(19) United States
(12) Patent Application Publication
(10) Pub. No.: US 2003/0206184 A1
(43) Pub. Date: Nov. 6, 2003

(54) Displaying content in different resolutions

(76) Inventor: Alexander V. Reshetov, San Jose, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/139,709

(22) Filed: May 6, 2002

(51) Int. Cl. G09G 5/00

(52) U.S. Cl. 345/667

(57) ABSTRACT

A display device includes a controller and an interface to display content or media (e.g., image or video data) intended for one resolution into another resolution. The controller may associate a set of neighboring pixels with a target pixel within a first display content of a first resolution. Based on an indication derived from less than all of the neighboring pixels in the first display content of the first resolution, a second display content of a second resolution may be generated. The interface may be operably coupled to the controller to display the second display content of the second resolution. In one embodiment, a combination of neighboring pixels that reduces a cost function may be determined. Using a traveling salesman algorithm, an indication may be derived from pixel characteristics for a target pixel to reconstruct a first display content of a lower resolution into a second display content of a higher resolution by minimizing the cost function.

### BACKGROUND

This invention relates generally to displaying information, and more particularly to displaying content in different resolutions.

Image or video processing involves synthesizing, capturing, manipulating and analyzing display information. An imaging device can capture optical images and convert them to suitable format for further processing. Alternatively, artificial images may be synthesized especially when image creation is computationally expensive. In a typical imaging system, optical components may be used to focus a graphic image onto an array of pixel sensors that electrically capture the image or video and output analog signals, which are then converted by analog-to-digital converters into digital signals for further processing by display devices. A graphic image is a continuously varying array of shades and colors. In a display process, an image may be sampled into a rectangular array of pixels, with each pixel having an (x, y) coordinate that corresponds to its location within the image. The number of pixels in an image or a video frame depends on how finely the graphic image is sampled.

Among other things, the cost of an imaging device is a function of its resolution, i.e., the higher the resolution the more expensive the imaging device. To display a higher resolution image, an image of higher resolution is to be produced. For example, to capture an 8½×11 inch document using a 300-dots-per-inch (DPI) scan requires an image resolution of 2550×3300 pixels. However, inexpensive imaging devices, such as digital cameras (e.g., still-shot cameras, and video cameras) may have resolutions far below this and thus cannot capture images with the desired detail.

Displaying an image of one resolution into another resolution may be difficult because of this mismatch of the resolution of the content created or captured by an imaging device and an available resolution on a displaying device. For example, display content or media intended for a traditional cathode ray tube (CRT) display device, captured from traditional video capture (640×480 pixels per image frame) or formatted for digital versatile drive (DVD) format (740×480 pixels per image frame) is typically of a lower resolution than one image resolution usually available on higher resolution display devices. Therefore, an image obtained at a lower resolution may not be displayed into an image of a desired resolution with sufficient details on a higher resolution display device, inadequately utilizing finer display capabilities of higher resolution display devices.

Thus, there is a continuing need for better ways to display content or media intended for one resolution into another resolution, especially in higher resolution.

### BRIEF DESCRIPTION OF THE DRAWINGS

FIG. 1 is a schematic depiction of a display system including a higher resolution display that runs a scaling program to transform display content/media, such as a lower resolution image or video consistent with one embodiment of the present invention;

FIG. 2A is a schematic depiction of a neighborhood layout for processing pixels of a still image in the display content/media of FIG. 1 according to one embodiment of the present invention;

FIG. 2B is a schematic depiction of another neighborhood layout for processing pixels of a video stream in the display content/media of FIG. 1 according to another embodiment of the present invention;

FIG. 3 is a flow chart showing the higher resolution display of FIG. 1 that displays content in accordance with one embodiment of the present invention;

FIG. 4A is a hypothetical chart showing connections between lower resolution pixels in red-green-blue space before reconstructing the lower resolution image or video of FIG. 1 into higher resolution image or video according to one embodiment of the present invention;

FIG. 4B is a hypothetical chart showing a trajectory between reconstructed pixels of FIG. 4A in red-green-blue space based on the reconstructor software of FIG. 1 that uses a traveling salesman algorithm in accordance with one embodiment of the present invention; and

FIG. 5 is a flow chart showing the reconstructor software of FIG. 1 that uses a traveling salesman algorithm to reconstruct the lower resolution image or video of FIG. 1 for displaying purposes into higher resolution according to one embodiment of the present invention.

### DETAILED DESCRIPTION

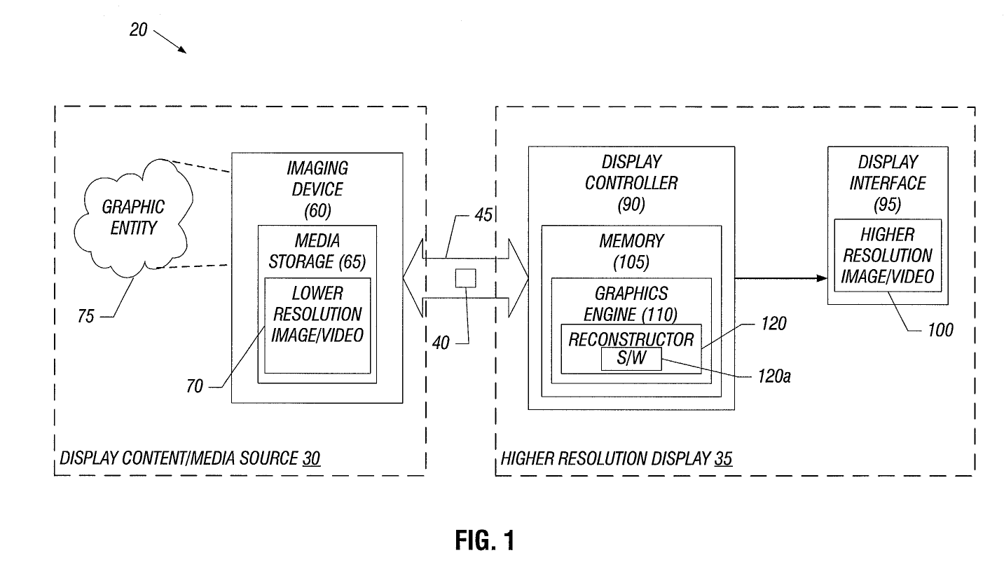

A display system 20, as shown in FIG. 1, includes a display content or media source 30 operably couplable to a higher resolution display 35 for providing display content or media 40. In one embodiment, imaging data or video stream data may be provided to the higher resolution display 35 via a link 45. Examples of the link 45 include any communication medium, such as a wireline or wireless link capable of communicating the display content or media 40. The display content or media 40 may be received over a network, in some embodiments.

The display content/media source 30 includes an imaging device 60 and media storage 65 storing a lower resolution image or video data 70 which may be either created or captured from a graphic entity 75 of a scene or an object, in one embodiment. The lower resolution image or video data 70 may be stored in one or more frames of pixel data. The imaging device 60 may transmit images or streams of data representing the graphic entity 75 to the higher resolution display 35 over the link 45. Examples of the imaging device 60 include a camera with video and still shot capturing ability or other suitable imaging devices capable of capturing one or more scenes or an object, forming an image or a video stream of the graphic entity 75.

The higher resolution display 35 may include a display controller 90 operably coupled to a display interface 95 that displays a higher resolution image or video 100. For the purposes of transforming the lower resolution image or video data 70 into the higher resolution image or video 100, the display controller 90 may include a memory 105 storing a graphics engine 110 in one embodiment of the present invention. To reconstruct or restore the lower resolution image or video data 70, the graphics engine 110 may comprise a reconstructor logic 120. Consistent with one embodiment of the present invention, reconstructor software 120a corresponding to the reconstructor logic 120 may be provided accordingly.

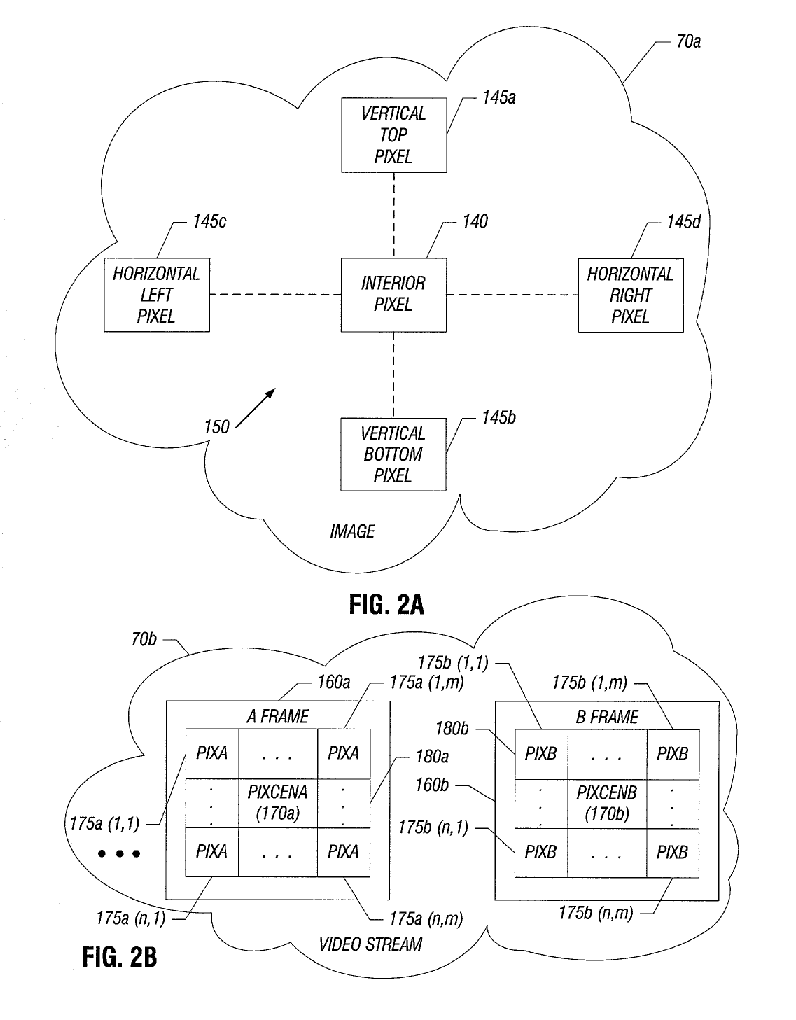

An image 70a that may be received in the display content or media 430 of a lower resolution is shown in FIG. 2A according to one embodiment of the present invention. The image 70a may comprise a plurality of pixels, depicting the graphic entity 75. To process the image 70a, a group of pixels may be associated with a selected pixel, providing a neighborhood of one or more pixels. In one embodiment, a target pixel, such as an interior pixel 140 may be selected according to a predefined criteria. For example, a pixel location may govern this process of target pixel selection. Other techniques are also possible for such purposes.

By associating a set of neighboring pixels 145a through 145d with the interior pixel 140 within the image 70a, a neighborhood 150 maybe formed in some embodiments. For each different interior pixel, a different set of neighboring pixels may be identified to construct a unique neighborhood, accordingly. For example, a clique is defined to be any subset of pixels in an image in which each element is a neighbor of any other element in one embodiment. One example of a clique is pair of pixels at a distance from each other (horizontal or vertical). For a regular lattice, such a clique creates a four-pixel neighborhood 150, in which each interior pixel 140 has four neighbors. In the illustrated case, for the interior pixel 140 a clique is defined that comprises the vertical top pixel 145a the vertical bottom pixel 145b, the horizontal left pixel 145c, and the horizontal right pixel 145d.

Like the image 70a shown in FIG. 2A, a video stream 70b may be received in the display content or media 40 of a lower resolution, as shown in FIG. 2B in accordance with one embodiment of the present invention. Typically, the video stream 70b may comprise a sequence of frames including a frame 160a and a frame 160b in some embodiments of the present invention.

Each frame 160 may comprise a plurality of pixels including a central pixel 170 having a predetermined number of neighboring pixels 175 associated therewith, forming a temporary group 180. For example, the group 180a constructed for the central pixel (PIXCENA) 170a within the frame 160a may include the neighboring pixels PIXA 175a (1, 1) through 175a (n, m). Likewise, for the central pixel (PIXCENB) 170b, the group 180b may include the neighboring pixels PIXB 175b (1, 1) through 175b (n, m). The central pixel 170 maybe selected based on the location of a pixel with each frame 160 in one embodiment. However, a desired number of pixels that define the frames 160 may be identified as the central pixel 170 while processing the video steam 70b.

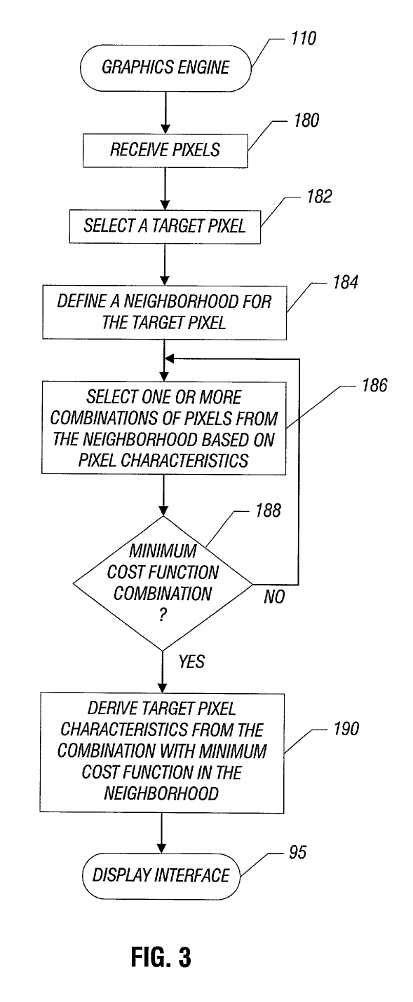

Referring to FIG. 3, the graphics engine 110 processes the lower resolution pixels (i.e., 140, 145a to 145d, 170a, 170b, 175a (1, 1) to 175a (n, m) and 175b (1, 1) to 175b (n, m) as shown in FIGS. 2A and 2B) for producing a higher resolution display at the display interface 95 according to one embodiment of the present invention. At block 180, the graphics engine 110 may receive the lower resolution pixels from a pixel source, such as the display content/media source 30.

Once a particular set of the lower resolution pixels, (e.g., the pixels including the interior pixel 140 and the neighboring pixels 145a through 145d of the image 70a shown in FIG. 2A) are defined, a target pixel may be selected at block 182. In one case, the target pixel may be the interior pixel 140. Using a predefined criteria, the neighboring pixels 145a through 145d may be associated with the interior pixel 140, defining the neighborhood 150 at block 184. Examples of the predefined criteria include a clique or a lattice. Based on the pixel characteristics of the neighboring pixels 145a through 145d, at block 186, one or more combinations of pixels may be formed.

A check at diamond 188 may determine a particular combination of the neighboring pixels 145a through 145d to be the one with a minimum cost function. However, any mathematical function may be utilized as a cost function to determine a combination of the neighboring pixels 175a (1, 1) through 175a (n, m) that includes less than all of the neighboring pixels 175a (1, 1) though 175a (n, m) may be used. In one embodiment, a conventional traveling salesman algorithm is used for such purposes. Other techniques that use a cost function may advantageously be deployed in some embodiments. At block 190, from the combination with a minimum cost function in the neighborhood 150, pixel characteristics for the target pixel, i.e., the interior pixel 140 may be derived.

In one embodiment, image data may be captured in a sequence of images to derive a particular sequence of pixels to generate the image 70a of the lower resolution pixels. The traveling salesman algorithm may be used to ascertain whether the sequence of pixels is associated with an object (e.g., the graphic entity 75 shown in FIG. 1). Thus, the chance that the particular sequence of pixels taken from this sequence of images are all samples of the object may be maximized.

By calculating an indication based on the cost function, the traveling salesman algorithm may determine that a certain combination is of the minimum cost function. That is, a pixel value, such as pixel intensity for the interior pixel 140 may be derived using the neighboring pixels 145a through 145d for transforming the image 70a into an image of a higher resolution in accordance with one embodiment of the present invention.

In another embodiment, video data may be captured in a sequence of frames, i.e., the frame 160a and frame 160b to derive a plurality of spatially located pixels across each of the sequence of frame, generating the video stream 70b. Using the traveling salesman algorithm the higher resolution display 35, the graphics engine 110 may ascertain whether the plurality of spatially located pixels are associated with a scene captured in the video stream 70b. By taking advantage of the fact that neighboring pixels 175a (1, 1) through 175a (n, m) in the frame 160a may ideally be the neighboring pixels 175b (1, 1) through 175b (n, m) in the frame 160b, and by identifying the combination of such pixels that minimize a particular cost function, a pixel characteristic, such as pixel intensity for the target pixel, i.e., the central pixel (PIXCENB) 170b may be computed. In the context of video resolution, a cost function is the difference between pixel characteristics of these neighboring pixels from one frame to another frame.

Consistent with one embodiment of the present invention, a conventional traveling salesman approach is applied in which a traveling salesman must visit several scattered “cities.” Traditionally, this approach is useful in determining a route must he or she take to minimize the overall amount of traveling. In the context of video resolution, however, the cities correspond to the pixels that represent a sample of a particular object that may have different physical locations in each of several frames in a sequence. The process of minimizing the salesman's travel time translates into maximizing the chance that a particular sequence of pixels taken from a sequence of images are all samples of the same object.

To this end, one embodiment of the present invention uses a set of neighborhood forming and reconstruction process related parameters. Examples of a neighborhood forming parameter include a definition of a clique, such as a rectangular neighborhood in one case. Of course, there are different ways the neighborhood of pixels may be defined, such as from frame to frame. Additional parameters including a number of neighboring pixels may be defined in each neighborhood as “NN,” which may be same for each neighborhood, for example. Likewise, a number of neighboring pixels to consider during reconstruction may be defined, as “NR,” where by definition, “NR<NN.”

The reconstructor software 120a shown in FIG. 3, however, may be suitably modified to encompass a different neighborhood and/or clique definition. For instance, the reconstructor software 120a may be extended into video reconstruction, where the neighborhood may be defined as a cube in a three dimensional (3D) space. One embodiment of the reconstructor software 120a is capable of capturing essential properties of images and videos, namely spatial and temporal (between frames in video sequence) correlation.

The reconstructor software 120a performs a reconstruction process that approximates a true value of a pixel characteristic associated with a target pixel (e.g., the interior pixel 140 or the central pixels PIXCENA 170a and PIXCENB 170b) using respective neighboring pixels, as described above. For example, the RGB color values for the respective neighboring pixels may be indicated in a three dimensional space. For this purpose, a traveling salesman problem (TSP) may be solved using an approximation technique that involves minimizing a cost function in some embodiments.

Essentially, the TSP may be formulated as given a finite number of RGB points along with the cost of travel between each pair of RGB points, identify the cheapest way of visiting all the RGB points and returning to the starting RGB point. In one case, the RGB points correspond to the RGB color values and, in turn, the cost is the geometrical distance between the RGB color values. Of course, different cost functions may be evaluated. Moreover, different strategies for tracking how the neighborhood of interesting pixels might migrate over time, effecting the quality of the tracking, and/or the cost of performing such tracking may be formulated in some embodiments of the present invention. While the original TSP may be solved in the illustrated embodiment, other suitable path planning techniques may be deployed in some embodiments of the present invention. In particular, a path planning approach based on non-closed-paths may be used in one embodiment of the present invention.

For a given NR (i.e., the number of the RGB color values to be considered during the reconstruction process), a sub-path of the trajectory, which has a minimum target value, is indicated. However, there are multiple possible ways for defining the sub-path of the trajectory. In one embodiment, it is the sum of deviations from a average value of the RGB color values. The RGB color values from the sub-path may then be used to approximate the true value of the pixel characteristic, such as the pixel intensity associated with a target pixel (e.g., the interior pixel 140, or the central pixels PIXCENA 170a and PIXCENB 170b). In one embodiment, averaging is used; in another embodiment, the median value may be calculated for this purpose.

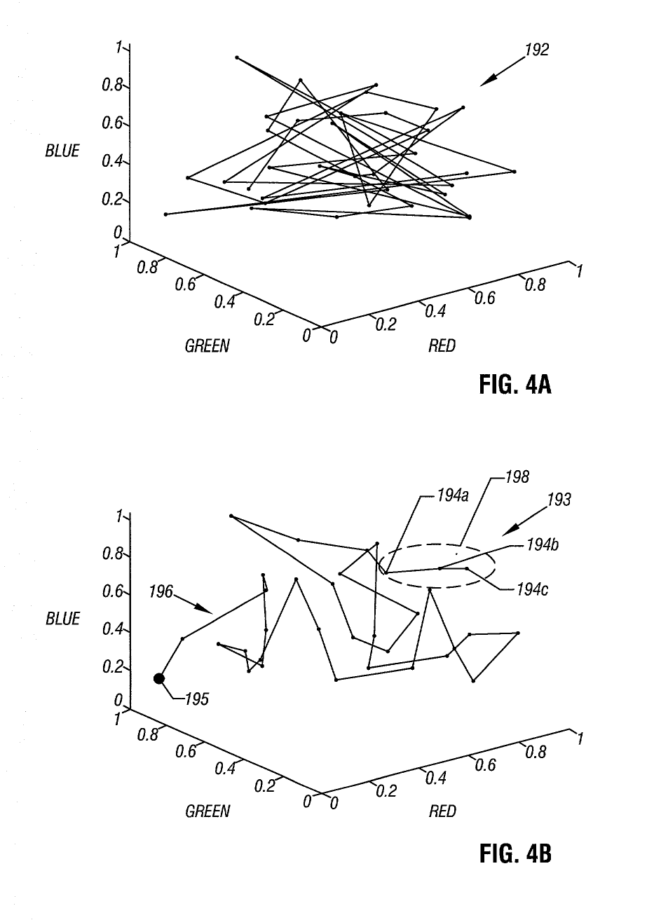

A TSP challenge is illustrated in FIGS. 4A and 4B. In FIG. 4A, 35 RGB points are plotted in their original order as one example. FIG. 4B shows the same RGB points connected using an approximation of the TSP based on a cost function. Within a red-green-blue space, for example, original connections (i.e., with no minimization of a cost function) between RGB color values of lower resolution pixels 192 are shown in FIG. 4A for the image 70a shown in FIG. 2A in accordance with one embodiment of the present invention. For reconstructing the lower resolution image 70a into a higher resolution image, the reconstructor software 120a uses a traveling salesman algorithm. From RGB color values of the reconstructed pixels 193, shown in FIG. 4B, a particular set of RGB color values 194a through 194c associated with neighboring pixels 145a through 145c may be selected, as an example.

In the illustrated embodiment, by starting a tour of all the lower resolution pixels 192 from a starting point 195 on a trajectory 196, a sub-path 198 including the RGB color values 194a through 194c may be formed. Based on the sub-path 198, a RGB color value for the interior pixel 140 shown in FIG. 2A may be determined in some embodiments.

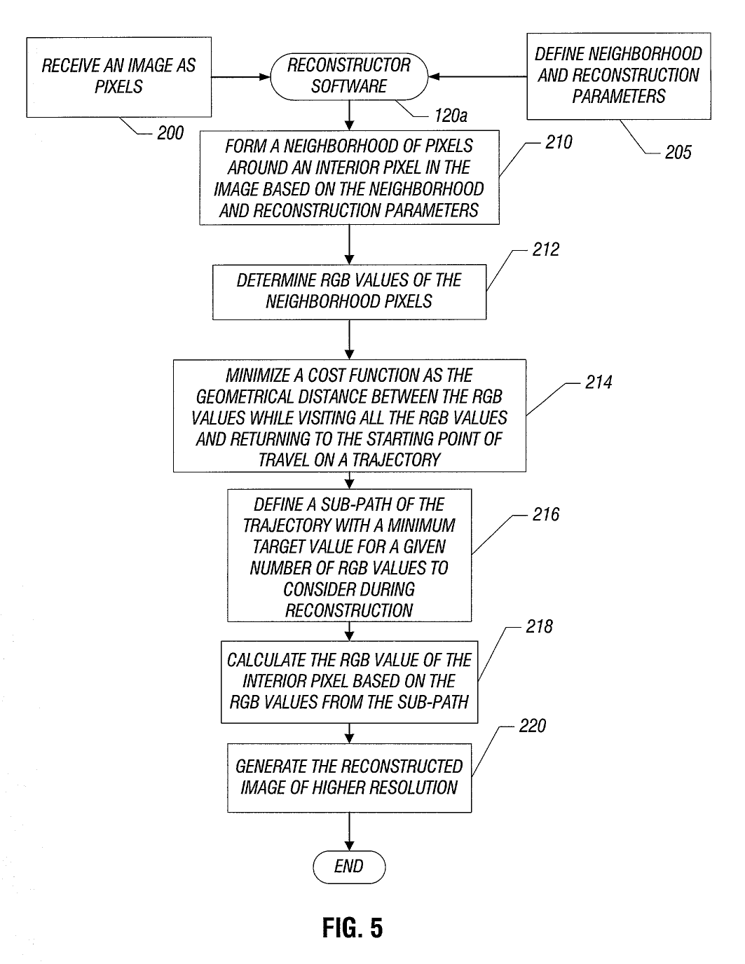

Consistent with one embodiment of the present invention, for displaying the lower resolution image/video 70 shown in FIG. 1 into the higher resolution image/video 100, the reconstructor software 120a uses a traveling salesman algorithm in FIG. 5. An image, such as that of the graphic entity 75 may be received at block 200 as pixels, which may be processed by the reconstructor software 120a. In order to process the pixels, appropriate neighborhood forming and reconstruction process related parameters (e.g., NN, NR) may be defined at block 205. Using the pixels of the lower resolution image/video 70 and the specified parameters, at block 210, the neighborhood 150 of the pixels around the interior pixel 140 may be formed. Then the pixel characteristics, such as red-green-blue (RGB) color values may be determined for the pixels included in the neighborhood 150 at block 212.

More specifically, a cost function may be evaluated based on the traveling salesman algorithm in accordance with one embodiment of the present invention. In one case, the trajectory 196 may be generated such that the cost function of the traveling salesman algorithm is reduced. In one embodiment, by using the geometrical distance between the RGB color values 194a through 194c as a cost while visiting all the RGB color values and returning to the starting point 195 of travel on the trajectory 196, the cost function may be minimized for the trajectory 196 at block 214. Thereafter, the sub-path 198 of the trajectory 196 with a minimum target value for a given reconstruction process related parameter (e.g., NR) may be defined at block 216. Based on the geometrical distance between the RGB color values 194a through 194c from the sub-path 198, the RGB color value of the interior pixel 140 is calculated at block 218. In this way, at block 220, a reconstructed image of a higher resolution corresponding to the image 70a may be generated for further display at the display interface 95 within the higher resolution display 35.

Accordingly, in some embodiments, video and image super-resolution may be achieved by applying the reconstruction process as described above to magnify or scale an image of one resolution into an image of a higher resolution, capitalizing on temporal information stored in a sequence of images, statistical data derived from sequences of images, and motions of the camera and/or subjects in the images. To this end, data may be extracted from frames from the “past” of any given time in a sequence, and from the “future” frames relative to this time in the sequence, a greater degree of interpolation may be performed, yielding images that either have higher quality for a given resolution, or allowing for greater magnification of an image with a given degree of quality.

In the case of image super-resolution, the image 70a may be scanned repeatedly, and the subtle random differences from scan to scan may be exploited. Alternatively, some jitter may be purposely introduced by applying vibration to the imaging device 60. In the case of video super-resolution, the fact that the imaging device 60, such as a camera which is usually moving and/or the graphic entity 75 is moving provides the additional data that may be exploited. In addition, artificial jitter may be introduced by vibrating the imaging device 60, such as a scanner.

Because only the neighborhoods for either the interior or central pixels are constructed without embodying a connection between global properties of the object (e.g., the graphic entity 75), and local properties (described as a neighborhood), image and video super-resolution may be advantageously provided in some embodiments of the present invention. According to another embodiment, based on the concept of a pixel's neighborhood that makes decisions about a reconstructed characteristic of an interior 140 or a central pixel 170a, 170b, an image restoration algorithm may be provided.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
associating a set of neighboring pixels with a target pixel within a first display content of a first resolution; and
transforming the first display content into a second display content of a second resolution based on an indication derived from less than all of the neighboring pixels in the first display content of the first resolution.

2. The method of claim 1 including:
receiving a plurality of pixels representative of said first display content; and
selecting the target pixel from the plurality of pixels based on a pixel location within said first display content.

3. The method of claim 2 including defining for each different target pixel a different set of neighboring pixels forming a unique neighborhood.

4. The method of claim 3 including:
selecting one or more neighboring pixels from the set of neighboring pixels to form a combination of neighboring pixels based on pixel characteristics associated with said unique neighborhood; and
determining whether the combination of neighboring pixels reduces a cost function.

5. The method of claim 4 including if the combination of neighboring pixels minimizes the cost function, deriving target pixel characteristics for the target pixel using the pixel characteristics of the combination.

6. The method of claim 5 including minimizing said cost function using a traveling salesman algorithm by calculating said indication for the combination of neighboring pixels.

7. The method of claim 6 including:
reconstructing the first display content of the first resolution into the second display content of the second resolution; and
displaying the second display content of the second resolution in a higher resolution relative to the first resolution.

8. The method of claim 6 including:
capturing image data in a sequence of images to derive a sequence of pixels to generate said first display content; and
using the traveling salesman algorithm to ascertain whether the sequence of pixels is associated with an object.

9. The method of claim 6 including:
capturing video data in a sequence of frames to derive a plurality of spatially located pixels across each of the sequence of frames to generate said first display content; and
using the traveling salesman algorithm to ascertain whether the plurality of spatially located pixels are associated with a scene.

10. The method of claim 6, wherein calculating said indication including determining intensity for the target pixel.

11. An apparatus comprising:
a controller that associates a set of neighboring pixels with a target pixel within a first display content of a first resolution to provide a second display content of a second resolution based on an indication derived from less than all of the neighboring pixels in the first display content; and
an interface operably coupled to said controller to display the second display content of the higher resolution.

12. The apparatus of claim 11, wherein the controller comprising a storage device storing a graphics engine to receive a plurality of pixels representative of said first display content and select the target pixel therefrom based on a pixel location within said first display content.

13. The apparatus of claim 12, wherein the graphics engine comprising a reconstructor to define for each different target pixel a different set of neighboring pixels forming a unique neighborhood.

14. The apparatus of claim 13, wherein the reconstructor to:
select one or more neighboring pixels from the set of neighboring pixels to form a combination of neighboring pixels based on pixel characteristics associated with said unique neighborhood; and
determine whether the combination of neighboring pixels reduces a cost function.

15. The apparatus of claim 13, wherein the reconstructor to use the pixel characteristics of the combination of the neighboring pixels to derive target pixel characteristics for the target pixel if the combination minimizes the cost function.

16. The apparatus of claim 15, wherein the reconstructor comprising a traveling salesman algorithm that minimizes said cost function to reconstruct the first display content of the lower resolution into the second display content of the higher resolution by calculating said indication for the combination of neighboring pixels.

17. The apparatus of claim 16, wherein the interface comprising a higher resolution display device that displays the second display content of the higher resolution thereon.

18. The apparatus of claim 16, wherein the first display content comprising image data of a sequence of pixels across one or more images for an object.

19. The apparatus of claim 16, wherein the first display content comprising video data of a plurality of spatially located pixels across one or more frames for a scene.

20. The apparatus of claim 16, wherein the traveling salesman algorithm to calculate said indication to determine intensity for the target pixel.

21. An article comprising a medium storing instructions that, if executed, enable a processor-based system to perform steps comprising:
associating a set of neighboring pixels with a target pixel within a first display content of a first resolution; and
transforming the first display content into a second display content of a second resolution based on an indication derived from less than all of the neighboring pixels of the set of neighboring pixels in the first display content of the first resolution.

22. The article of claim 21, comprising a medium storing instructions that, if executed, enable a processor-based system to perform steps comprising:
receiving a plurality of pixels representative of said first display content; and
selecting the target pixel from the plurality of pixels based on a pixel location within said first display content.

23. The article of claim 22, comprising a medium storing instructions that, if executed, enable a processor-based system to perform steps comprising defining for each different target pixel a different set of neighboring pixels forming a unique neighborhood.

24. The article of claim 23, comprising a medium storing instructions that, if executed, enable a processor-based system to perform steps comprising:
selecting one or more neighboring pixels from the set of neighboring pixels to form a combination of neighboring pixels based on pixel characteristics associated with said unique neighborhood; and
determining whether the combination of neighboring pixels reduces a cost function.

25. The article of claim 24, comprising a medium storing instructions that, if executed, enable a processor-based system to perform steps comprising deriving target pixel characteristics for the target pixel if the combination of neighboring pixels minimizes the cost function using the pixel characteristics of the combination.

26. The article of claim 25, comprising a medium storing instructions that, if executed, enable a processor-based system to perform steps comprising minimizing said cost function using a traveling salesman algorithm by calculating said indication for the combination of neighboring pixels.

27. The article of claim 26, comprising a medium storing instructions that, if executed, enable a processor-based system to perform steps comprising:
reconstructing the first display content of the first resolution into the second display content of the second resolution; and
displaying the second display content of the second resolution in a higher resolution relative to the first resolution.

28. The article of claim 26, comprising a medium storing instructions that, if executed, enable a processor-based system to perform steps comprising:
capturing image data in a sequence of images to derive a sequence of pixels to generate said first display content; and
using the traveling salesman algorithm to ascertain whether the sequence of pixels is associated with an object.

29. The article of claim 26, comprising a medium storing instructions that, if executed, enable a processor-based system to perform steps comprising:
capturing video data in a sequence of frames to derive a plurality of spatially located pixels across each of the sequence of frames to generate said first display content; and
using the traveling salesman algorithm to ascertain whether the plurality of spatially located pixels are associated with a scene.

30. The article of claim 26, comprising a medium storing instructions that, if executed, enable a processor-based system to perform steps comprising calculating said indication including determining intensity for the target pixel.
